(19) United States
(12) Patent Application Publication
(10) Pub. No.: US 2005/0192880 A1
(43) Pub. Date: Sep. 1, 2005

(54) Data transmission system and method

(76) Inventors: Tomihiro Yamamoto, Kashihara-shi (JP); Tsukasa Oshima, Osaka (JP)

Correspondence Address: MCDERMOTT WILL & EMERY LLP, 600 13TH STREET, N.W., WASHINGTON, DC, 20005-3096, US

(21) Appl. No.: 11/006,816

(22) Filed: Dec. 8, 2004

(30) Foreign Application Priority Data
Dec. 8, 2003 (JP) 2003-408518

(51) Int. Cl. G06F 17/60

(52) U.S. Cl. 705/35

(57) ABSTRACT

A transmission system for performing electronic business transactions and the like that simply assures the transmission order to another party as necessary, while performing distributed processing of messages received from a party. After receiving a message the system identifies the transmission source of the message. It acquires control information for selecting a line for processing the message. Using the control information, the system determines whether to select processing lines in the order the messages are received or not. In case of determining not to select processing lines in the order received, the system selects, based on the transmission source of the received message, to process the message by the same line as other messages from the same transmission source.

### BACKGROUND OF THE INVENTION

1. Field of the Invention

This invention relates to a transmission system and transmission method for, upon receiving messages such as messages for business transactions between businesses, performing distributed processing of the messages, and outputting the processed messages in sequential order to the transmission destination.

2. Description of the Related Art

In recent years, performing business transactions between businesses using Electronic Data Interchange has increased. Moreover, Internet EDI in which messages are exchanged using an application protocol such as FTP or HTTP on the Internet over a telecommunications line has emerged, making it even easier for businesses to use an EDI system. As the number of clients performing transactions using EDI increases, the number of combinations of transaction parties increases multiplicatively, and thus a large quantity of transmission processing occurs in the transmission system that makes it possible to exchange messages between those parties. Conventionally, in order to prevent the occurrence of trouble due to delays in message transmission, a plurality of processing lines were used, and according to the load condition, distributed processing was conducted using those processing lines. For example, when messages are sent in succession, processing of the messages is divided up over the processing lines using a round robin method. FIG. 16 is a function block diagram for explaining an example of an apparatus that selects processing lines using a round robin method for all received messages. The apparatus 151 in this example exchanges messages between systems 101 to 103 on the ordering side and systems 201 to 203 on the order-receiving side. The communication unit 152 of the apparatus 151 performs communication with the systems 101 to 103 on the ordering side by way of the communications line 301, and performs communication with systems 201 to 203 on the order-receiving side by way of the communications line 302. For example, when a plurality of messages, such as ordering information, are received from systems 101 to 103 on the ordering side, the distribution unit 153 of the apparatus 151 changes the processing lines to which the messages are distributed in the order that the respective messages are received. After going through an entire cycle of processing lines, the line that was selected at the start of distribution is selected as the line for processing the message received next. The post-processing unit 154 after the processing line stage performs post processing for the messages processed by the lines selected using the round robin method in this way.

In the electronic business transactions, in order to maintain consistency in the transactions, the order of message transmission may be important. For example, in the case in which cancellation information is sent for canceling an order after the order information has already been sent, it is necessary that the cancellation information be received after the order information. When cancellation information is received before the order information, the cancellation is for an order that does not exist, so the order-receiving side is unable to perform processing properly.

However, when distributed processing is performed using a plurality of lines, even though the processing lines are changed in the order that the messages are received, as the number of transactions increases and different sized data increases, the load condition for each line becomes non-uniform. When the processing time for each line is longer than the interval between message transmissions, the message transmission order may change.

As disclosed in Japanese unexamined patent publication No. H6-83741, even when conducting distributed processing in this way, by attaching serial numbers or date/time information to the data in order to indicate the transmission order, it is possible to restore the transmission order on the receiving side based on the attached information.

### SUMMARY OF THE INVENTION

When using serial numbers and dates and times for expressing the transmission order as described above, if the order is not guaranteed in the distributed processing, it is necessary to confirm and restore the transmission order of the messages on the receiving side based on the serial numbers and dates and times. When restoring all of the messages, the load required for that processing becomes very large, and the processing time becomes long. Therefore, even in the case of distributed processing, a system is desirable that is capable of simply assuring the transmission order without hindering the electronic transaction.

Taking into consideration the problems with the prior technology, the object of this invention is to provide a transmission system and method that are capable of simply assuring the transmission order of messages as necessary when performing distributed processing.

The transmission system provided by this invention is a system for processing a received message by a processing line selected from among a plurality of processing lines, and outputting the message to the transmission destination, and it employs the following construction in order to accomplish the object described above.

After this transmission system receives a message from a party with whom messages are exchanged, an identification unit identifies the transmission source of the message. Also, an acquisition unit acquires control information for selecting a line for processing the message. A determination unit uses the control information to determine whether to select processing lines in the order that messages are received or not. In the case of determining that processing lines is not selected in the order that messages are received, a selection unit, based on the transmission source of the received message, selects the same processing line for messages having the same transmission source. For example, by converting a code that expresses the transmission source to a numerical value, and then performing processing based on the remainder obtained from dividing that conversion result by the number of processing lines, the same line can be selected for messages from the same transmission source. A plurality of messages are processed in succession by each line, so in this case, when messages processed in that order are transmitted to another party, it is possible to assure the transmission order of messages from the same transmission source. Also, in the case where it is not necessary to assure the transmission order of the messages, the processing lines for the messages are selected in the order that the messages are received, so processing of the messages is distributed over the respective lines.

From another aspect, this invention provides a transmission method that corresponds to the transmission system described above. This transmission method processes a received message by a processing line selected from among a plurality of processing lines, and then outputs the message to the transmission destination, and comprises the steps of: identifying the transmission source of the received message; acquiring control information for selecting a line for processing the message; using that control information to determine whether to select processing lines in the order that messages are received or not; and in the case of determining that processing lines is not selected in the order that messages are received, selecting, based on the transmission source of the received message, the same processing line for messages having the same transmission source.

From yet another aspect, this invention provides a program for causing a computer to execute the steps of the method described above, and a computer readable medium bearing the program.

By adopting this kind of construction, this invention makes it possible to simply assure the transmission order of messages as necessary while performing distributed processing of messages. As a result, it is possible to quickly and smoothly perform electronic business transactions.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing showing the basic construction of the transmission system of an embodiment of the invention.

FIG. 2 is a drawing showing the hardware construction of a processing apparatus.

FIG. 3 is a drawing for explaining the hardware construction of the system on the ordering side.

FIG. 4 is a flowchart for illustrating the transmission method of this invention.

FIG. 5 is a drawing showing a correlation table for correlating the user codes with the company code.

FIGS. 6A, 6B and 6C are drawings showing an example of the format of an EDI message.

FIG. 7 is a drawing showing a correlation table for correlating the company code, post ID, business transaction code and test classification.

FIG. 8 is a drawing showing a correlation table for correlating the program ID, business transaction code, test classification, starting-line number, ending-line number and line-distributing method.

FIG. 9 is a drawing showing the times of receiving messages and the lengths of time necessary for performing processing of the messages.

FIG. 10 is a drawing showing the course of time of processing when selecting processing lines for all messages using a round robin method.

FIG. 11 is a drawing showing the course of time of processing when selecting processing lines for a plurality of messages according to this invention.

FIG. 12 is a function block diagram for explaining a different example of construction of the transmission system of this invention.

FIG. 13 is a drawing showing the hardware construction of the processing apparatus in a different example of the construction of the invention.

FIG. 14 is a drawing showing an example of a line-management table.

FIG. 15 is a flowchart for illustrating the procedure of the transmission method in a different example of the construction of this invention.

FIG. 16 is a function block diagram for showing the basic construction of the transmission system that selects processing lines for all messages using a round robin method.

### DESCRIPTION OF THE PREFERRED EMBODIMENTS

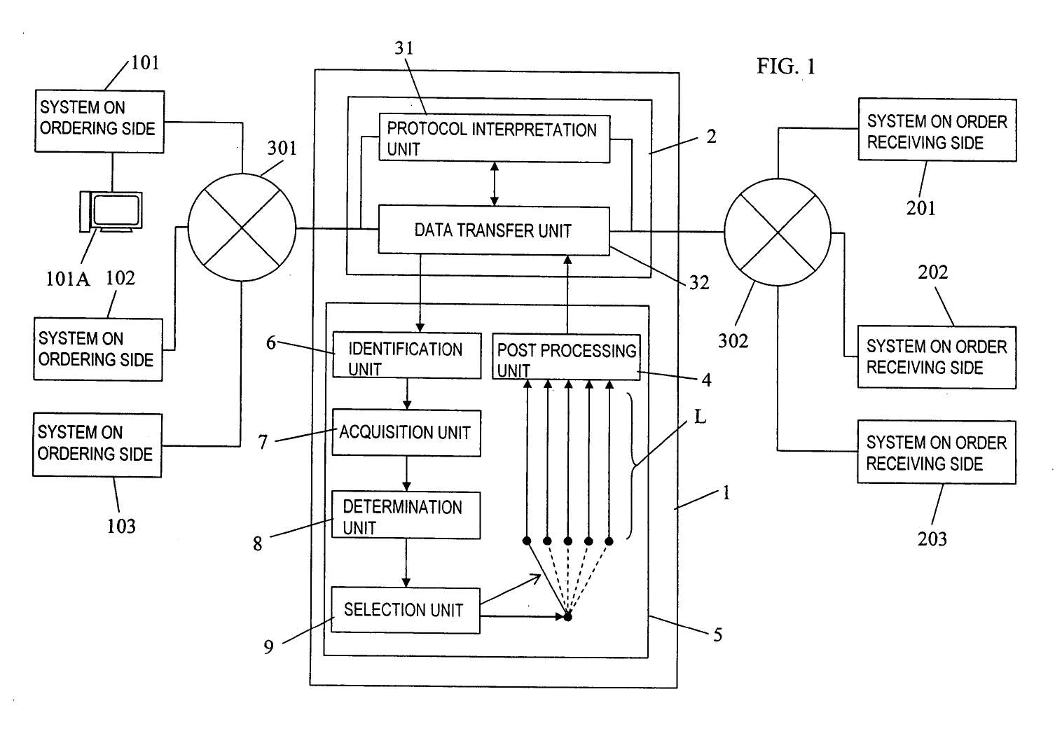

In the preferred embodiments, the invention is embodied as a transmission system for exchanging messages between an ordering side and order-receiving side. As shown in FIG. 1, in this transmission system, a processing apparatus 1 for processing messages is located between systems 101, 102 and 103 on the ordering side, and systems 201, 202 and 203 on the order-receiving side.

This processing apparatus 1 is connected to a plurality of systems 101, 102 and 103 on the ordering side by way of a communications line 301, and is connected to a plurality of systems 201, 202 and 203 on the order-receiving side byway of a communications line 302. Each system 101, 102 or 103 on the ordering side and each system 201, 202 or 203 on the order-receiving side may belong to the same company or organization, or may belong to different companies or organizations. Also, for the sake of convenience, in FIG. 1, the systems are classified into an ordering side and an order-receiving side, and divided by two communication lines, however, this doesn't mean that each system must be classified to just one side, or must be divided by two communication lines.

The Internet or an Intranet can be used as the communications lines 301 and 302 that connect the processing apparatus 1 to the systems 101, 102 or 103 on the ordering side, and to the systems 201, 202 or 203 on the order-receiving side. Here it is presumed that a TCP/IP network will be used, and FTP will be used as the application protocol for transmitting messages. Here, a plurality of EDI messages is collected into one file and that file is transmitted.

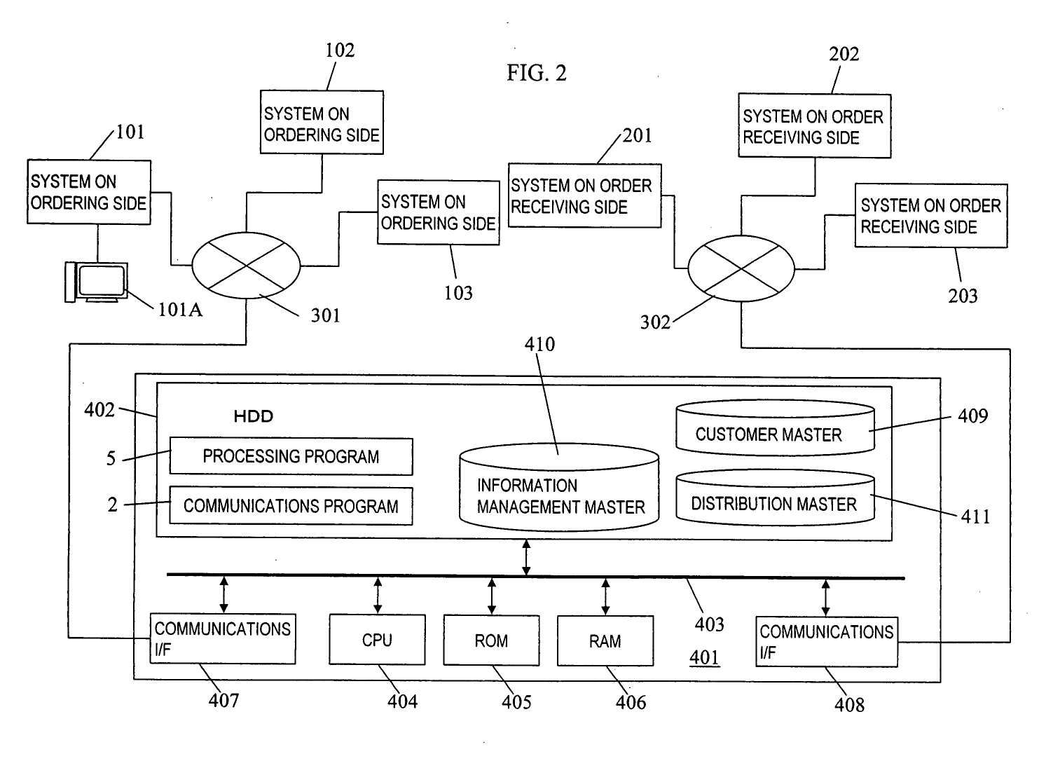

The processing apparatus 1 can be realized by one or more general-purpose computers. FIG. 2 shows an example of a processing apparatus realized by one computer. In order to perform communication using FTP, a communications program 2 such as a FTP server program or FTP client program operates on that computer 401. Here, the communications program 2 is stored in a HDD (Hard Disk Drive) 402. The HDD 402 is connected to a CPU (Central Processing Unit) 404 by way of a bus 403. A ROM (Read Only Memory) 405, RAM (Random Access Memory) 406, communications interface 407 and communications interface 408 are also connected to the bus 403. After the computer is activated by an instruction from a program stored in the ROM 405, the CPU 404 reads the communications program 2 from the HDD 402, and operates the communications program 2 using the RAM 406. The CPU 404 communicates with external network devices according to instructions from the communications program 2. The communications interface 407 or 408 is used for that communication. The communications interfaces 407 and 408 are connected to respective communications lines 301 and 302, and communications interface 407 is used for communication with systems 101 to 103 on the ordering side, and communications interface 408 is used for communication with systems 201 to 203 on the order-receiving side.

After receiving a message from system 101, 102 or 103 on the ordering side, or from system 201, 202 or 203 on the order-receiving side, the processing apparatus 1 performs processing that corresponds to the message, and outputs a received message to the transmission destination.

In order that problems due to delays in message transmission do not occur, a plurality of processing lines are located in the processing apparatus as shown by simulation in FIG. 1. The processing apparatus 1 performs distributed processing by distributing the received messages to selected processing lines L, and then after post processing is performed by the post-processing unit 4 located after the processing lines, outputs the received messages to the transmission destination. For example, as the post processing, messages are sorted according to each transmission destination, or a plurality of messages are combined into one.

The processing lines L for processing messages can be prepared using software or hardware. In the case of realizing the processing apparatus 1 using one computer, by having the program distribute resources such as the CPU processing time or memory, it is possible to prepare a plurality of processing lines L using software. Also, in the case of realizing the processing apparatus 1 using a plurality of computers, by using one of the computers for one processing line, it is possible to prepare a plurality of processing lines using hardware. Furthermore, it is also possible to maintain more processing lines than the number of computers by combining both methods, and preparing processing lines using software for each of the plurality of computers.

The systems on the ordering side and the systems on the order-receiving side exchange various kinds of messages such as an estimate request, response to an estimate request, order information, order-contract information, delivery-date confirmation information, delivery-date response information, and the like by way of the communication lines and processing apparatus. In addition to items that are directly related to the business transaction, the messages may also contain items notifying of past performance or news.

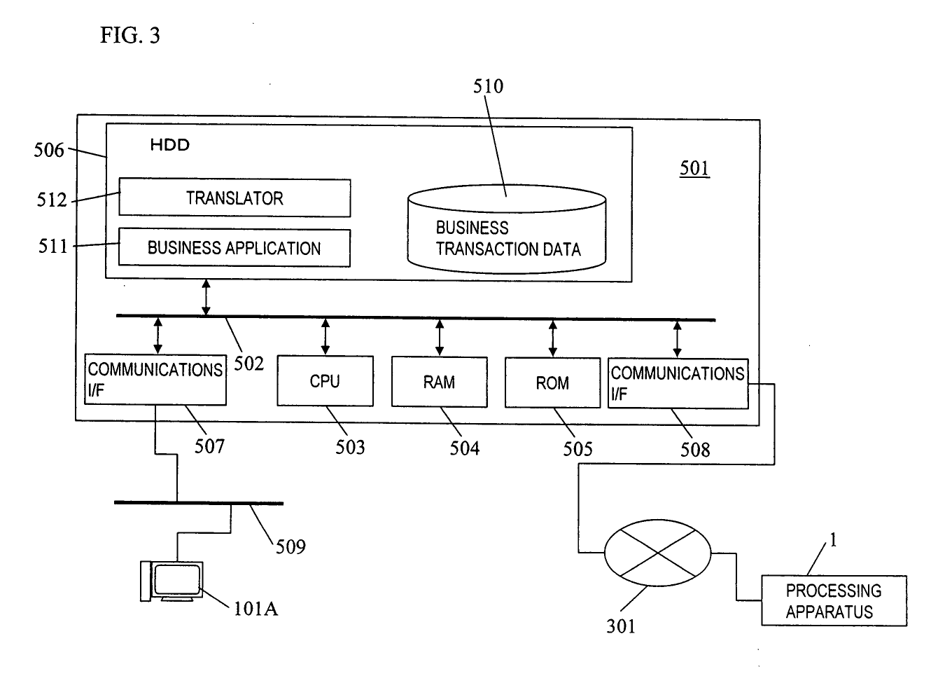

The persons in charge enter the necessary information for these messages from terminals that are connected to the systems 101, 102 and 103 on the ordering side and systems 201, 202 and 203 on the order-receiving side, and use the terminals to confirm the contents of the messages. For example, when a person in charge enters order information from the terminal 101A that is connected to the system 101 on the ordering side, the system 101 on the ordering side sends that message. The systems 101 to 103 on the ordering side can also be realized using a computer. FIG. 3 shows an example of a system on the ordering side that is realized using a general-purpose computer. The computer 501 comprises a bus 502, and this bus 502 connects a CPU 503, RAM 504, ROM 505 and HDD 506. Moreover, in addition to these devices, communications interfaces 507 and 508 are connected to the bus 502 in order to perform communication with external devices. The terminal 101A used by the person in charge is connected to the communications interface 507 by way of that company's LAN (Local Area Network) 509. Together with a business transaction database 510, a business application 511 is stored in the HDD 506. The business transaction database 510 stores business transaction data for estimates, orders, and the like. The CPU 503 reads the business application 511 from the HDD 506, and runs it using the RAM 504. The CPU 503 accesses the business transaction data stored in the business transaction database 510 according to instructions from the business application 511. The business transaction data is often created in a format unique to a company. In the case of using a standard format for EDI message transmission, it is necessary to perform conversion from that unique format to the standard format. In order to perform that conversion, a translator program 512 is also stored in the HDD 506. The CPU 503 reads that translator program 512 from the HDD 506, and runs it using the RAM 504. The CPU 503 reads business transaction data from the business transaction database 511 and creates EDI messages by converting the format of that data to standard format according to instructions from the translator program 512. On the other hand, the systems 201 to 203 on the ordering side, using a translator program, converts messages from the standard format to a format unique to a company.

When there is a need to send a created EDI message, the system 101 on the ordering side immediately or at proper timing accesses the communications program 2 in the processing apparatus 1. The computer 401 operates according to instructions from the communications program 2 such as the FTP server, and as shown in FIG. 1, the processing apparatus 1 comprises a protocol interpretation unit 31 and data transfer unit 32. The protocol interpretation unit 31 manages data transfer by the data transfer unit 32 according to commands from the access source. When the communications program 2 in the processing apparatus 1 is accessed, the system 101 on the ordering side sends authorization information that contains the user name and password to the FTP server in order to connect to the control connection. When authorization is performed properly, the protocol interpretation unit 31 establishes a data connection with the system 101 on the ordering side. Through the data connection, the system 101 on the ordering side sends a message, and the data transfer unit 32 receives the message. In this embodiment, the message is sent to the processing apparatus 1 by sending a file in which a plurality of EDI messages is stored. When sending a file from the system 101 on the ordering side, the file is divided into a plurality of packets. A header is added to each packet according to a TCP/IP protocol stack. The computer 401 uses the headers to restore the file from those packets. The CPU 405 of the computer 401 obtains the messages from the file.

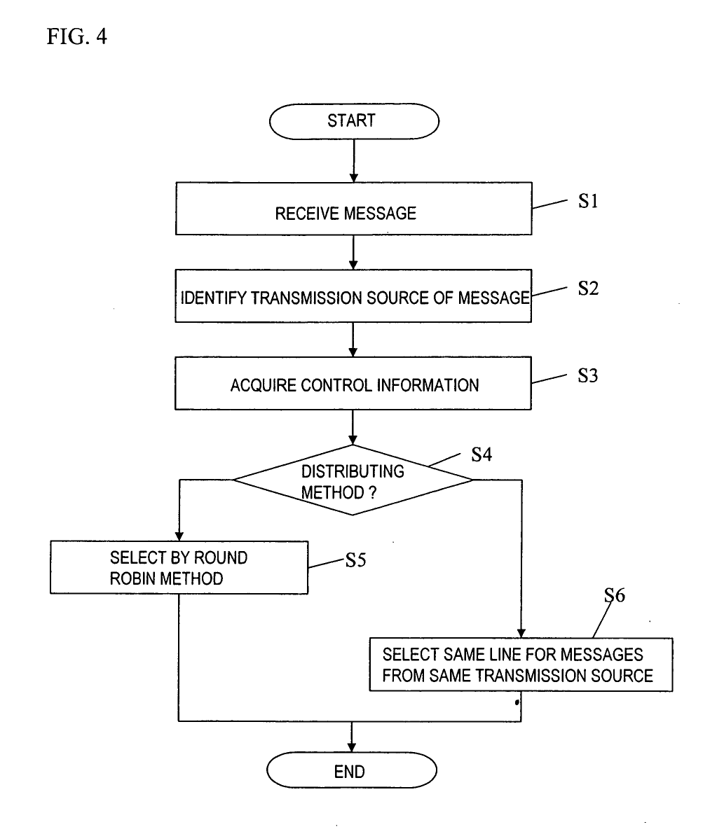

After receiving the EDI message, the processing apparatus 1 performs processing corresponding to the message according to the procedure shown in FIG. 4, and selects a processing line L for sending the processed message to the transmission destination specified by the message. When the processing apparatus 1 is realized by a computer, a program 5 is used for controlling the selection of the processing line L. In the example shown in FIG. 2, that program 5 is also stored in the HDD 402. The program 5 works together with the hardware, such as the CPU 404 and memory of the computer 401, and after the message is received (S1), has the computer 401 execute the method that includes step S2 to S6. At that time, the computer 401 functions as the identification unit 6, acquisition unit 7, determination unit 8 and selection unit 9 shown in FIG. 1.

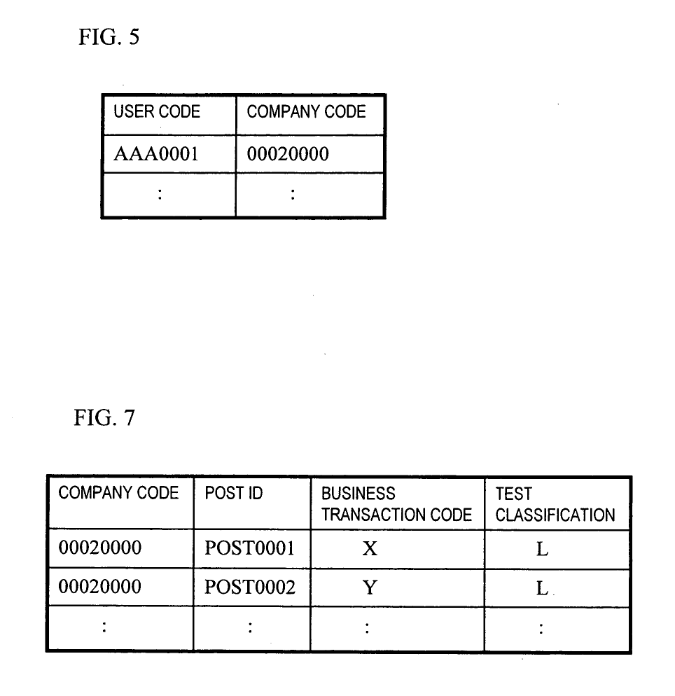

First, the identification unit 6 identifies the transmission source of the received message based on the authorization information (S2). The transmission source, for example, is the company to which the logged in user belongs. Here, as shown in FIG. 5, the user and company code are correlated beforehand by a table. The table is stored in the storage unit of the computer 401. For example, as shown in FIG. 2, the table can be stored in the HDD 402 as a customer master file 409. The identification unit 6 references the table and identifies the company code that corresponds to the logged in user.

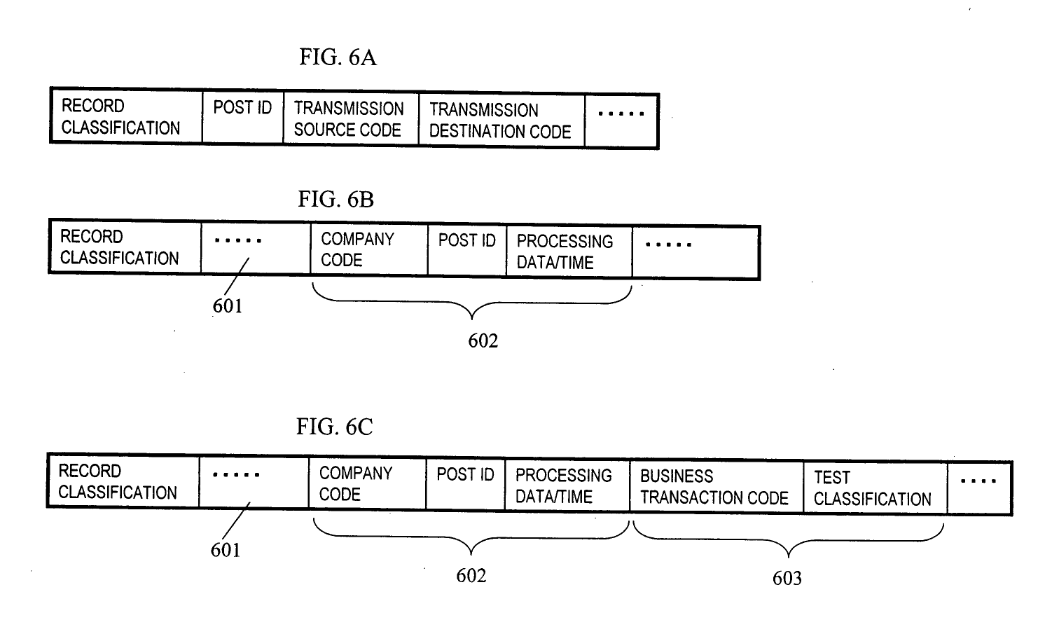

After identifying the company code, the identification unit 6 acquires the post ID that indicates the type of message from the received message. The type is the type specified by the person in charge at the ordering source, and it includes the type of business for which the message is used. FIG. 6A shows an example of the format of an EDI message. In this example, in addition to the post ID, the message also contains a record classification, transmission source code, transmission destination code, and the like. The message can be divided into a header record and data record. The record classification indicates whether the record is a header record or data record. The transmission source code and transmission destination code indicate codes that are unique to the transmission source and transmission destination of the message. The message is sent to the system on the order receiving side that corresponds to the transmission destination code.

After acquiring the post ID, as shown in FIG. 6B, the identification unit 6 edits the header 601 of the received message, and adds management information 602 for data processing that comprises the company code, post ID and processing date/time.

After management information 602 has been added to the header 601 of the received message, the acquisition unit 7 acquires control information for selecting a processing line for processing the message (S3). In order to do that, the acquisition unit 7 extracts the company code and post ID from the management information, and as shown in FIG. 7, references a correlation table that correlates the company code, post ID, business transaction code and test classification. As shown in FIG. 2, this table can be stored in the HDD 402 of the computer 401 as an information management table 410. The business transaction code is a code that indicates the type of business transaction being handled and the type of data transmitted. For example, the business transaction code indicates items such as an order, changes in an order, cancellation of an order, performance report, and news. In the example shown in FIG. 7, the business transaction code [X] corresponds to an order, changes in an order and cancellation of an order, and the business transaction code [Y] corresponds to a performance report and news. The test classification indicates whether the received message is a test transmission, actual transmission, or concurrent actual transmission.

In this embodiment, by referencing the table 410, the acquisition unit 7 acquires the business transaction code and test classification that correspond to the company code and post ID as control information. As shown in FIG. 6C, the acquisition unit 7 edits the header 601 of the received message, and adds that control information 603.

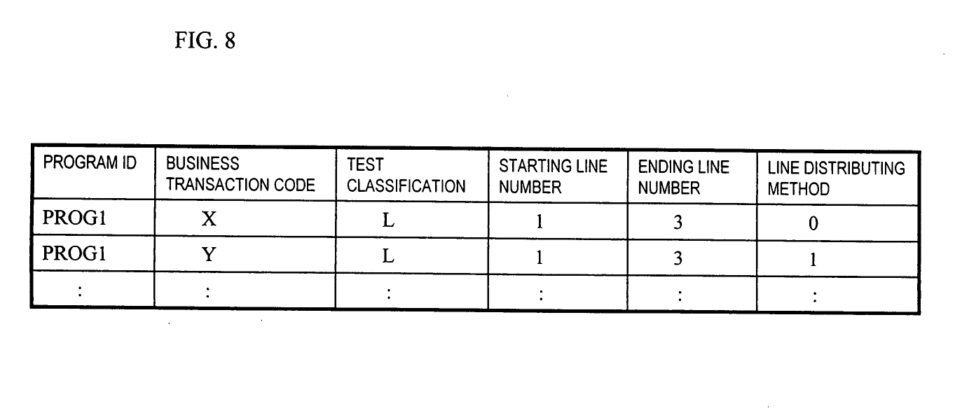

After the control information 603 has been added to the header 601 of the received message, the determination unit 8 determines, based on that control information, whether to select processing lines for the messages in the order that the messages are received or not (S4). In order to do that, the determination unit 8 references a correlation table that correlates the program ID, business transaction code, test classification, starting-line number, ending-line number and line distributing method, as shown in FIG. 8. As shown in FIG. 2, this table can be stored in the HDD 402 of the computer 401 as a distribution master table 411. The program ID is an ID for identifying a program for processing the message. The message is processed by the processing program identified by this program ID. The starting-line number is the number of the line where distributing of the message starts. The ending-line number is the number of the line where distributing of the message ends. The line distributing method indicates whether or not to use the round robin method for distributing lines for the message, and is given two values for example. In the example shown in FIG. 8, ‘0’ indicates that the round robin method is used, and ‘1’ indicates that the round robin method is not used. When line distributing is to be performed using the round robin method, the processing lines L for the messages are selected in the order that the messages are received. By referencing a table such as that stored in the storage unit of the computer, the determination unit 8 identifies the distributing method that corresponds to the received message, and sets whether or not to use the round robin method. Furthermore, it identifies the program, starting-line number and ending-line number corresponding to the message.

In case of being determined that the round robin method is to be used, the selection unit 9 selects the processing line L for the message in the order received (S5). When a plurality of messages are received by receiving one file that contains a plurality of messages, the receiving order for those messages can be according to the order set for the file.

When the starting-line number is 1 and the ending-line number is 3, for example, then the processing line L for respective messages are selected in the order of the first, second and third line, in the order that the plurality of messages is received. After the third line has been selected, and the round robin method is used, the first line is selected for the next received message, and selection is similarly performed for following messages. When the starting-line number is 2 and the ending-line number is 4, then the lines are selected in the order of the second, third and fourth line.

On the other hand, in the case of being determined that the round robin method is not to be used, the selection unit 9 performs a process of selecting the same line for messages from the same transmission source based on the source of the received message (S6). In order to do that, the selection unit 9 can convert the company code that indicates the transmission source to a numerical value, and select a processing line L based on the remainder obtained when that converted result is divided by the number of lines. For example, when the number of lines is 2 and the company codes for three messages are ‘00020000’, ‘00020001’ and ‘0002000A’, then the selection unit 9 extracts the lowest-order digit from respective company codes, ‘0’, ‘1’ and ‘A’. By expressing the values in character code, ‘0’ becomes 0×30[48], ‘1’ becomes 0×31[49] and ‘A’ becomes 0×41 [65], so the remainder obtained when dividing these values by the number of lines is found. In the case of the first, the calculation is 48÷2, so the remainder is 0. In the case of the second, the calculation is 49÷2, so the remainder is 1. In the case of the third, the calculation is 65÷2, so the remainder is 1. When the remainder is 0, the selection unit 9 selects the first line as the processing line L for that message, and when the remainder is 1, it selects the second line as the processing line L for that message. With this kind of calculation, when the company code is the same, the remainder always becomes the same value, so the same line is selected for messages from the same transmission source.

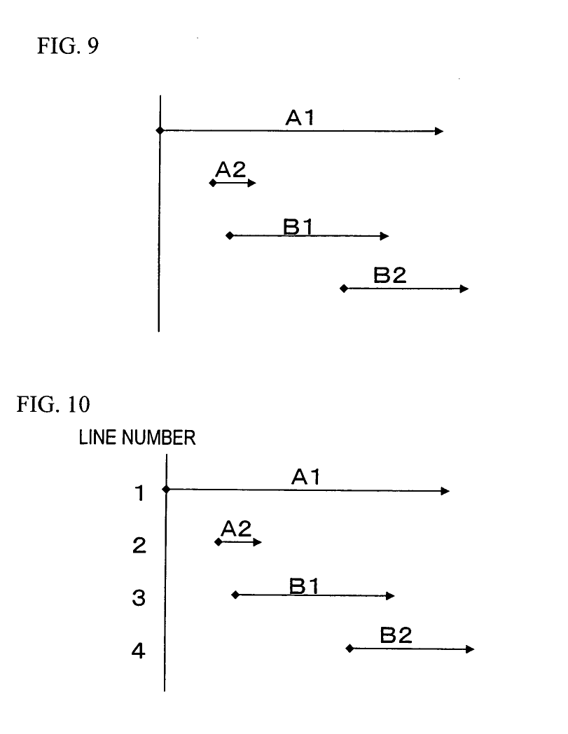

For example, suppose that four messages A1, A2, B1 and B2 having different times necessary for processing are sent from systems 101 and 102 on the ordering side, and that the processing apparatus 1 receives these messages in this order. Also, suppose that messages A1 and A2 are messages sent from system 101 to system 201 on the order-receiving side, and the messages B1 and B2 are messages sent from system 102 to system 202 on the order-receiving side. In FIG. 9, the time required for processing messages A1, A2, B1 and B2 is represented by the length of the arrow, and time that the message is received is indicated by the nock of the arrow.

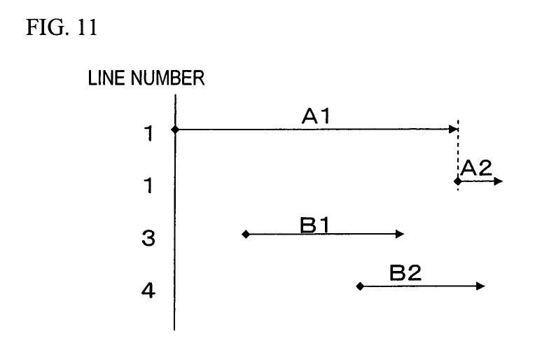

FIG. 10 shows the course of time for processing when processing lines are selected for these messages using the round robin method, and FIG. 11 shows the course of time for processing when processing lines are selected according to this invention. In FIG. 10 and FIG. 11, the four lines for processing these messages are indicated by the numbers 1 to 4, and the processing time for each message is represented by the length of the arrow. Furthermore, the starting time for processing each message is indicated by the nock of the arrow and the ending time is indicated by the tip of arrow.

In the example shown in FIG. 10, messages A1, A2, B1 and B2 are processed concurrently by the first, second, third and fourth lines, respectively, and processing ends in the order of message A2, B1, A1 and B2. After post processing has been performed by the post processing unit 4, these messages are sent in that order from the processing apparatus 1 to system 201 and 202. In the system 202, the messages are received in the order of message B1 and B2, so even though those messages may correspond to an order and to a cancellation of the order, there is no problem with the transaction. However, in the system 201, the messages are received in the order of message A2 and A1, so the order that they are sent from the system 101 differs from the order they are received. In this case, trouble occurs in the transaction when these messages correspond to an order and cancellation of the order, and not to a performance report and news.

On the other hand, in the example in FIG. 11, messages A1, A2, B1 and B2 are processed by the first, first, third and fourth lines, respectively. For example, messages A1 and A2 correspond to an order and a cancellation of the order, and for these messages it is determined not to select processing lines using the round robin method. Moreover, messages B1 and B2 correspond to a performance report and news, and for these messages it is determined to select processing lines using the round robin method. As a result, the messages A1 and A2 from the same transmission source are processed in succession by the same processing lines, and messages B1 and B2 are processed concurrently by different processing lines. Therefore, processing of the four messages ends in the order that they were sent from the system 101. In this case, even though distributed processing is conducted, the order that the messages are sent from the system 101 is the same as the order that the messages are received by the system 201. In the case of performing an electronic business transaction, the order that the transaction information is generated is set chronologically according to its nature, and by normally selecting the same processing line to process messages from the same transmission source, no problems occur in the transaction. Also, in the case of the transmission source, it can be acquired from the message at the time when the message is received by the processing apparatus, so it becomes possible to perform processing more simply and quickly than other information.

In this way, with the transmission system and method of this embodiment, it is possible to easily assure the transmission order of messages as needed while performing distributed processing to delete queues for large-volume transaction. As a result, the transaction can be performed quickly and smoothly.

Messages from a transmission source may be processed with a processing line L that was selected for another transmission source in order to assure the message order. Also, the processing line can be included with the processing lines that are selected by the round robin method. The processing line can be used, as long as the order of the target messages does not change, for processing the messages from a different transmission source and messages whose order does need to be assured. However, there is a possibility that the load applied to the processing lines will be uneven among the processing lines. For example, when the load on a processing line becomes very large, such as in the case when many messages from the same transmission source are received in a short period of time, the processing line can be temporarily removed from the processing lines that are selected by the round robin method.

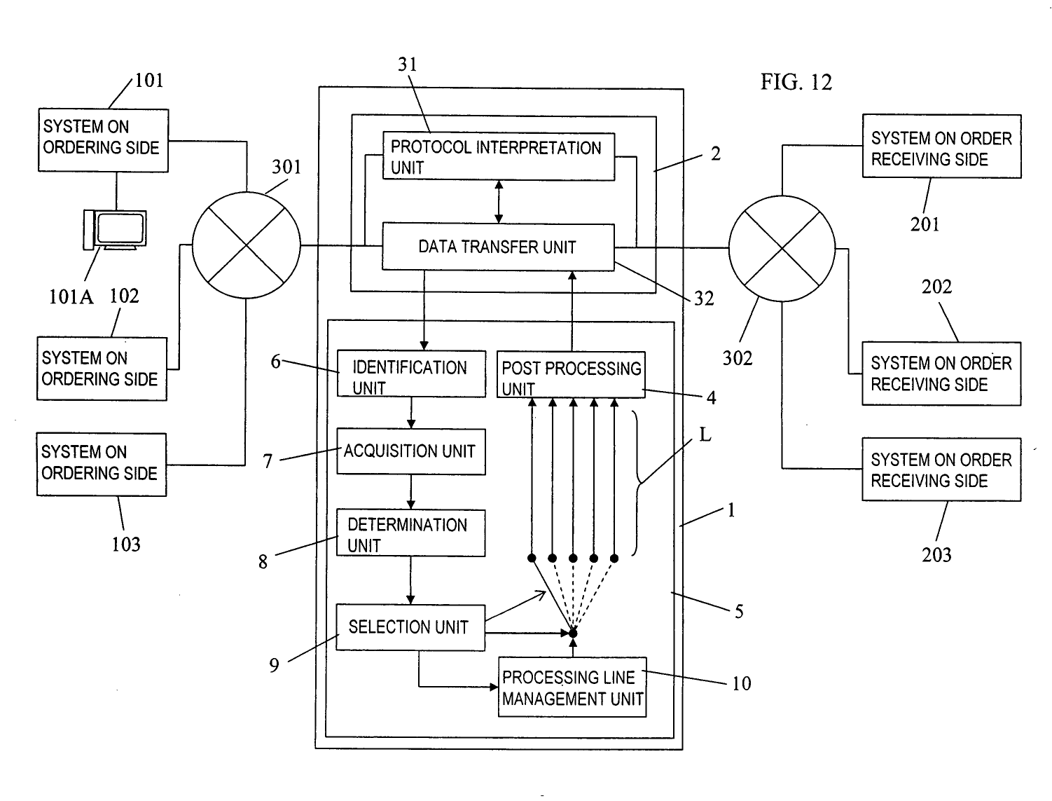

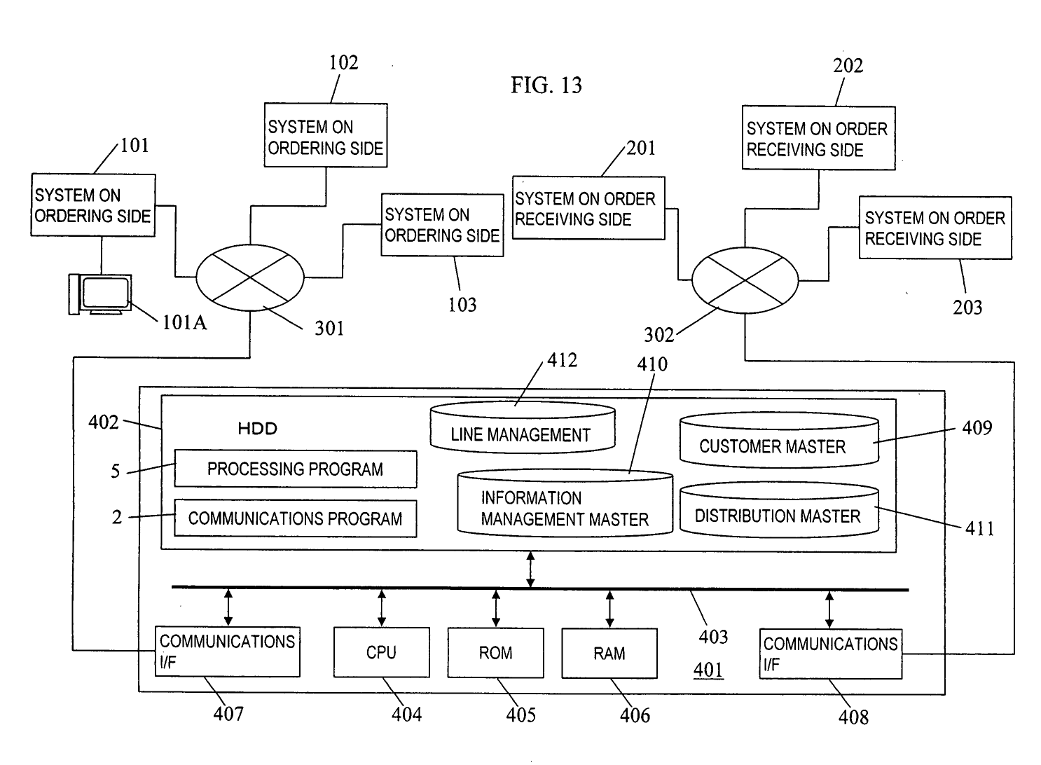

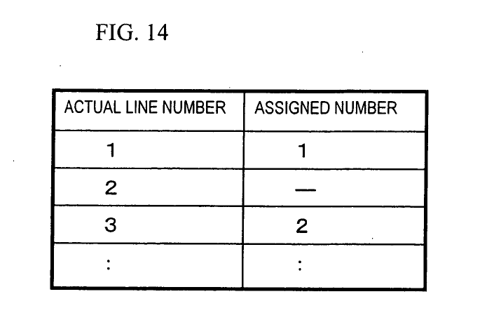

In that case, as shown in FIG. 12, the processing apparatus 1 can further comprise a processing line management unit 10. This processing line management unit 10 manages the processing lines based on the selection results by the selection unit 9 when it is determined to select processing lines in the order that messages are received. As shown in FIG. 13, in the case where a computer 401 functions as the processing line management unit 10, a line management table 412 is also stored in the HDD 402 of the computer 401. The line management table 412 is a table for managing the lines to be selected by the round robin method. FIG. 14 shows an example of a line management table. In this example, the actual line numbers are correlated with assigned numbers. Here, the actual line numbers are unique line numbers given to the processing lines. The assigned numbers are ID numbers that are given to the lines to be selected by the round robin method. When selecting lines by the round robin method, the selection unit 9 identifies the processing lines using the assigned numbers. In the case of the round robin method, processing lines that are not given assigned numbers are not selected. The line management table 412 may be edited in order to remove some processing lines from the processing lines that are selected by the round robin method.

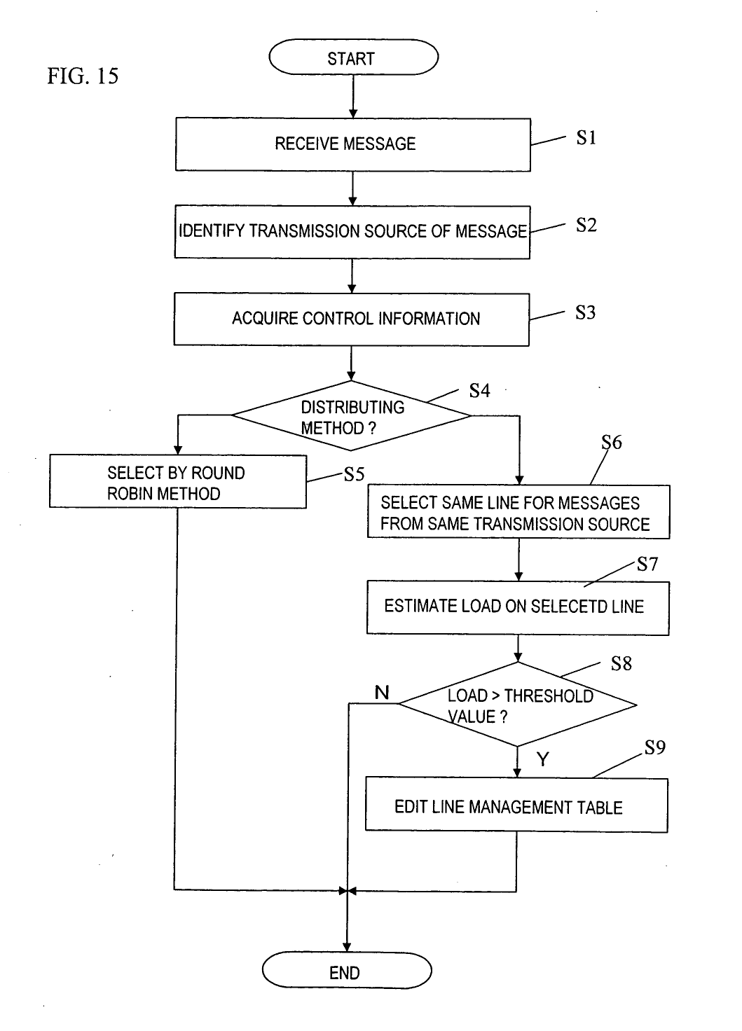

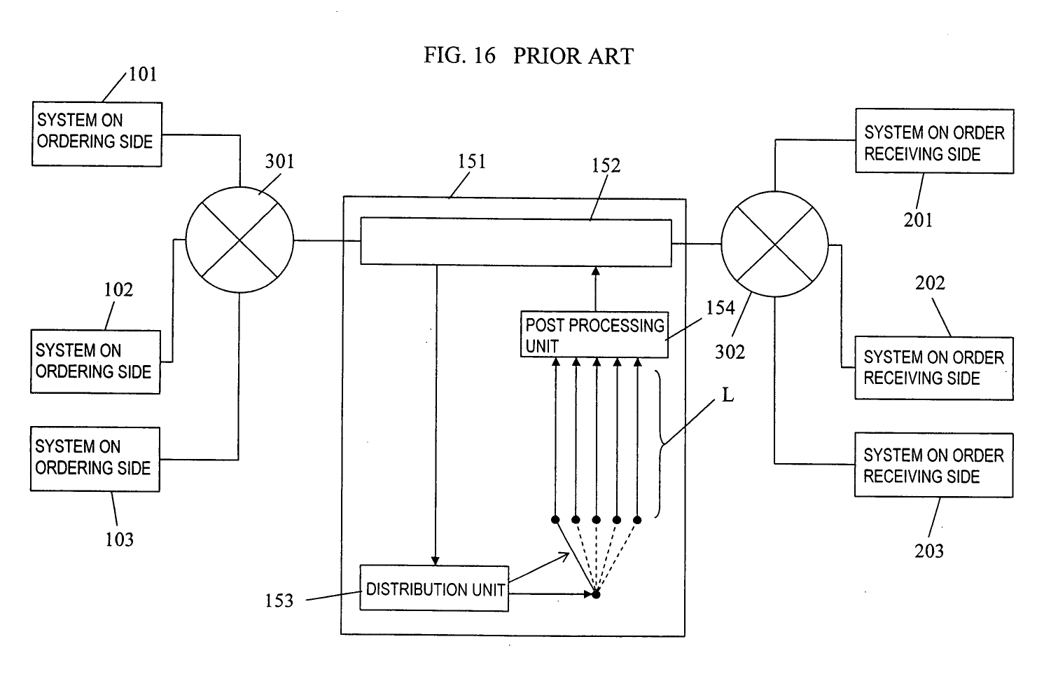

This editing can be performed after step S6 as shown in FIG. 15. After step S6, the CPU 404 of the computer 401 follows an instruction from the processing program 2 and estimates the load on the selected processing line (S7). This estimation can be performed based on the selection results up to that time for the processing line. For example, from the selection results it is possible to estimate the number of messages being processed by the processing line and total data length of the messages, and set the load from that estimation. After the CPU 404 calculates the load on the processing line, it compares that calculated value with a preset threshold value (S8). When the load on the processing line is no more than the threshold value, processing ends. When the load on the processing line is greater than that threshold value, the CPU 404 edits the line management table in order to remove the processing line from among the processing lines to be selected by the round robin method (S9). For example, the CPU 404 cancels the assigned number given to the processing line, and as necessary, changes other assigned numbers. By doing so, the possibility decreases that the load will become concentrated on part of the processing lines.

Moreover, when it is predicted that a large quantity of messages whose order must be assured are going to be constantly sent from the same transmission source, the processing line for processing those messages can be removed in advance from among the processing lines to be selected by the round robin method. When securing a processing line in advance for processing some messages in this way, it is preferred that the processing line management unit 10 manage the processing lines to be selected by the round robin method according to the load on the processing line. Even when it is predicted that a large quantity of messages whose order must be assured will constantly be sent from the same transmission source, temporarily reducing the number of messages received from the transmission source is also feasible. In that case, the overall performance of the processing lines drops. To avoid this, the load on the processing line is estimated. The estimation of the load can be performed every time a message is received from the transmission source, or periodically. When the load on the processing line is less than a preset threshold value, the processing line management unit 10 includes the processing line among the processing lines to be selected by the round robin method. For example, a number assigned on the line management table 412 is given to the processing line. By doing this, it is possible to prevent a drop in the overall performance of the processing lines. When the load on the processing line is no less than the threshold value, it is as planned, so the secured processing line is not included among the processing lines selected by the round robin method. Even though the processing is performed to include the secured processing line among the processing lines selected by the round robin method, the processing is only valid temporarily. For example, after the load on the secured processing line is estimated after an assigned number is given to that processing line, when the estimated value is no less than a threshold value, the processing line management unit 10 removes the processing line from among the processing lines to be selected by the round robin method. The threshold value used when removing the secured processing line from among the processing lines to be selected by the round robin method can be different than the threshold value used when including the processing line among the processing lines to be selected by the round robin method. Also, in the embodiment described above, FTP was used as the application protocol for exchanging messages, however the invention is not limited to this.

Moreover, it is not necessary to distinguish between the communications program, such as the FTP server program, and the program for controlling the selection of processing lines. It is possible to use one program that comprises both functions.

Also the program instructions can be given to the computer by using a computer readable medium. It is possible to use various media such as a storage medium or transmission medium as the computer readable medium. For example, by expressing the program instructions as an electrical signal, optical signal, magnetic signal, or the like, and then placing and sending that signal on a carrier wave, it is possible to provide the program to a third party using a transmission medium such as coaxial cable, copper wire or fiber optics. It is also possible to use wireless communication or infrared communication for sending the signal. Moreover, it is possible to use optical media such as a CD-ROM or DVD-ROM, magnetic media such as a floppy disk, or semiconductor memory such as flash memory or RAM as the recording medium.

This invention is capable of performing distributed processing of messages received from one of the transaction parties, and as necessary, simply assuring the transmission order of messages to another transaction party, and thus is effective as a transmission system, such as a system for electronic business transactions between companies.

The disclosure of Japanese Patent Application No. 2003-408518 filed Dec. 8, 2003 including specification, drawings and claims is incorporated herein by reference in its entirety.

The embodiment described above does not limit the technical scope of the present invention, and in addition to the embodiment already disclosed, various changes or applications are possible within the range of the invention.

1. A transmission system for processing a received message by a processing line selected from among a plurality of processing lines, and outputting the message to a transmission destination of the message, said transmission system comprising:
a unit configured to identify a transmission source of the received message;
a unit configured to acquire control information for selecting a line for processing the message;
a unit configured to determine, based on said control information, whether to select at least one processing line for messages in the order the messages are received or not; and
a selection unit configured to select, based on the transmission source of a received message, a same processing line for messages from a same transmission source, in case of determining not to select at least one processing line for messages in the order the messages are received.

2. The transmission system of claim 1 wherein said selection unit converts a code expressing the transmission source to a numerical value, and based on a remainder obtained when diving the conversion result by the number of processing lines, performs the process of selecting the same processing line for messages from the same transmission source.

3. A transmission system for processing a received EDI message by a processing line selected from among a plurality of processing lines, and outputting the message to a transmission destination of the message, said transmission system comprising:
a first table correlating a company code, a post ID, a business transaction code, and a test classification, said post ID expressing a type of an EDI message, said business transaction code expressing a type of a business transaction being handled and a type of data being transmitted;
a second table correlating the business transaction code, the test classification, an ID of a program for processing an EDI message, and a line distributing method;
a unit configured to identify the company code of the transmission source of the received EDI message;
a unit configured to acquire the post ID for the received EDI message, the business transaction code, and the test classification from the first table, said business transaction code and test classification corresponding to the identified company code;
a unit configured to identify a line distributing method corresponding to control information by referencing the second table, said control information containing the acquired business transaction code and test classification, and determine, according to the identified line distributing method, whether to select a processing line for the received EDI message by the round robin method or not; and a unit configured to select, based on the transmission source of the EDI message, to select a same line for messages from a same transmission source, in case of determining not to select a processing line for the EDI message by the round robin method.

4. A transmission method of processing a received message by a processing line selected from among a plurality of processing lines, and outputting the message to a transmission destination of the message, said transmission method comprising the steps of:
identifying the transmission source of the received message;
acquiring control information for selecting a line for processing the message;
determining, based on said control information, whether to select at least one processing line for messages in the order the messages are received or not; and
selecting, based on the transmission source of the received message, a same processing line for messages from a same transmission source, in case of determining not to select at least one processing line in the order the messages are received.

5. A computer readable medium bearing a program for causing a computer to execute the steps of a transmission method of claim 4.

6. A program for causing a computer to execute the steps of the transmission method of claim 4.
